(19) United States
(12) Patent Application Publication
(10) Pub. No.: US 2024/0428637 A1
(43) Pub. Date: Dec. 26, 2024

(54) SYSTEM AND APPARATUS FOR DETECTION USING CLOSURE DEVICE

(71) Applicant: Elm Company, Riyadh (SA)

(72) Inventors: Syed Salman Alam, Riyadh (SA); Najam Us Saqib, Riyadh (SA); Riad Souissi, Riyadh (SA)

(21) Appl. No.: 18/427,127

(22) Filed: Jan. 30, 2024

Related U.S. Application Data
(60) Provisional application No. 63/523,360, filed on Jun. 26, 2023.

(51) Int. Cl. G07C 9/30; H04W 4/12

(52) U.S. Cl. CPC G07C 9/30; H04W 4/12

(57) ABSTRACT

Disclosed herein are devices for detecting if a movable barrier obstructing a portal has been opened, the devices comprising: at least one sensor configured to detect when the barrier is manipulated from a closed position in which the portal is obstructed, to an open position enabling access to the portal; a processor configured to generate a first alert message when sensor data indicative of the barrier being manipulated from the closed position to the open position, is received; and a communication module for wirelessly transmitting the first alert message to a remote entity.

This application claims the benefit of priority to U.S. Provisional Application No. 63/523,360, filed Jun. 26, 2023, which is incorporated by reference in its entirety.

### TECHNICAL FIELD

The present disclosure generally relates to a device configured to monitors entrances of an enclosure and/or entrances to particular areas with an enclosure. Embodiments of the present disclosure also relate to a system monitoring entrances of the physical structure of a business and/or a particular enclosed area within the physical structure of the business. Embodiments of the present disclosure additionally relate to the inspection and seal tamper detection of the physical structure of the business.

### BACKGROUND

In certain circumstances restricting access to a building or to a room within a building, may be required. For example, municipality officers, regulators and/or law enforcement officers may need to restrict access for safety purposes. This might occur, for example, when a store or other publicly accessible premises does not comply with required levels of safety standards. In such circumstances, it is necessary for the relevant inspectors to restrict access to the store, or other publicly accessible premises, until the outstanding safety issues are resolved. Currently, the relevant authorities are required to physically check if a store owner whose store is the subject of an access restriction, is complying with the restriction. This is both time consuming and costly for the relevant authorities. In practice, it often occurs that the store owner grants access to the public to the store and/or premises whilst the outstanding safety issues are unresolved. Since compliance with the restriction notice is only manually verified by the relevant authorities, often such violations of a restriction notice go unnoticed.

A store owner, whose store is the subject of a restriction access, can currently reopen the store immediately after the relevant inspector leaves the premises. Inspecting the premises on a periodic basis to ascertain that the restriction notice is being complied with is impractical and often unfeasible, since such status checks are labor-intensive and inefficient use of time.

### SUMMARY

In accordance with an aspect of the disclosure there is provided a device for detecting if a movable barrier obstructing a portal has been opened. The device may comprise at least one sensor configured to detect when the barrier is manipulated from a closed position in which the portal is obstructed, to an open position enabling access to the portal; and a processor configured to generate a first alert message when sensor data indicative of the barrier being manipulated from the closed position to the open position, is received. The device may also comprise a communication module for wirelessly transmitting the first alert message to a remote entity. The movable barrier may relate to a door obstructing a doorway when closed, and enabling access to through the doorway when opened. The device may be used, for example, to detect unauthorized access to a secure location.

The device may be used to monitor access to a door. The door may relate to the entrance of a building, and could also encompass particular areas inside a building, such as a secured laboratory, storage area or high-sensitivity office. In short, the device may be affixed to and used to detect access to any type of door.

In accordance with one envisaged application, the device may be installed on the door of a shop, and the device can be used, for example, when shop inspectors find a violation and wants to seal and restrict access to the shop. In this example, the business or shop cannot be reopened until they pay the violation charges, and in the case of the shop reopening before paying the charger, the device detects the violation and reports to the regulator.

In certain embodiments, the device is an IoT device using 3G modem/NB-IoT with M2M Sim card for communication. This device may comprise multiple components. In some embodiments the device may comprise 4 types of sensors: GPS sensors, magnetic sensors, tamper sensors and accelerometers. The sensors may be interfaced with a microcontroller, which may also comprise a Bluetooth® Low Energy SOC (System on Chip). The device may detect whenever the door is opened from sensor signals generated by any one or more of the sensors, such as signals generated by the magnetic sensor and the accelerometer. When sensor signals are detected a communication module may be activated, such as a 3G GSM module, to call an API. The communication module may be powered off once data has been sent to a cloud server, to reduce power consumption. Generated sensor data may be used by the device to detect if it is being tampered with, and in response an alert may be sent to a cloud server. The device may comprise a rechargeable Li-ion battery. The device may be reused, and deployed in different environments.

In accordance with some embodiments, a short-range communication module, which may be comprised in the microcontroller may be used for short-range communication with, for example, a portable computing device, such as a mobile application on a smartphone. For example, Bluetooth® may be used to communicate with a mobile application running on a mobile computing device, such as a smartphone of a user. The mobile application may be used to configure the device. In addition, the mobile application may also be used as an interface to check a log of detected tampering violations experienced by the device. The log may be stored local to the device, or remotely from it in a remote server. Besides using the mobile application to check for violations, the mobile application may also comprise expansion headers enabling different environmental sensors to be retrofitted to the device to collect environmental information.

Further features of the disclosure include:
Tailor-made for the inspection use case;
Unique hardware which covers all aspects of tampering;
Low power IMU-based door movement algorithm;
Reusable device that will be installed on multiple business/shops; and
Wireless charging docking status in the car.

### BRIEF DESCRIPTION OF THE DRAWINGS

The accompanying drawings, which comprise a part of this specification, illustrate several embodiments and, together with the description, serve to explain the principles disclosed herein.

FIG. 1A is a schematic diagram of a device according to an embodiment of the present disclosure.

FIG. 1B is a schematic diagram of a device according to another embodiment of the present disclosure.

FIG. 2 is a process flow chart illustrating a startup sequence of the device of FIGS. 1A and 1B, according to an embodiment of the present disclosure.

FIG. 3 is a process flow chart illustrating a method for connecting a mobile device to the device of FIGS. 1A and/or 1B, according to an embodiment of the present disclosure.

FIG. 4 is a graph illustrating normalized sensor output data, according to an embodiment of the present disclosure.

FIG. 5 is a schematic diagram of a network comprising the device of FIGS. 1A and/or 1B and a backend server, architecture according to an embodiment of the present disclosure.

### DETAILED DESCRIPTION

For the purposes of non-limiting illustration, the following detailed description of embodiments will disclose use cases of the device being used to detect opening and/or closing of a door. The person of ordinary skill in the art will however appreciate from the ensuing disclosure, that the device may equally be used to detect opening of any movable barrier obstructing a portal, such as, for example, but not limited to, a drawer, a lid, a chest, and cupboard.

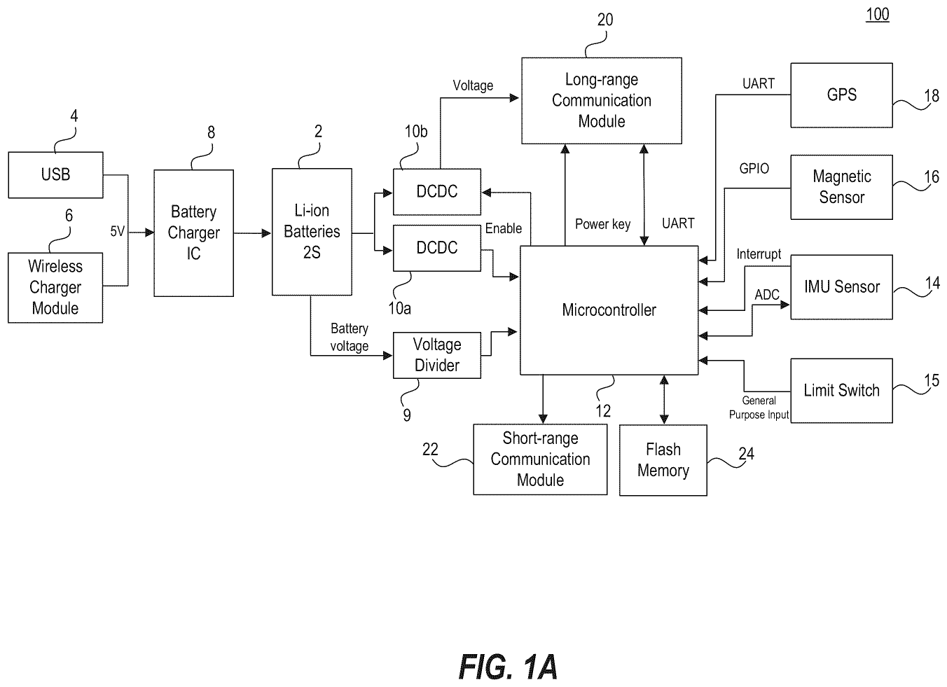

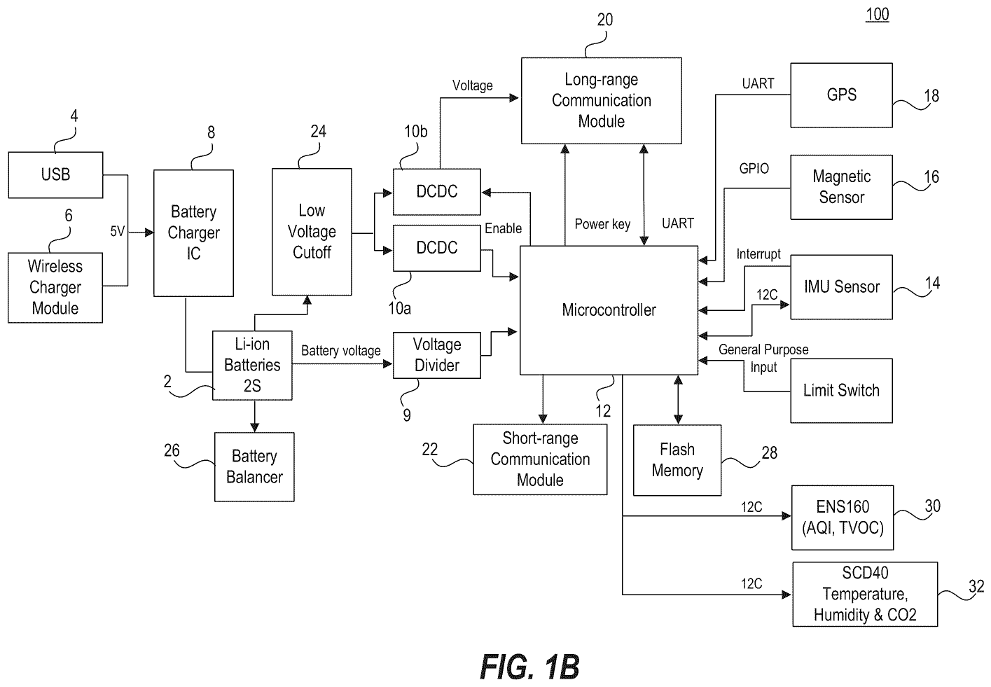

The device consists of multiple sections, battery management, voltage regulation, microcontroller, server communication, Bluetooth communication and sensors. FIGS. 1A and 1B present a schematic illustration of a device in accordance with the present disclosure.

### Battery Management

In accordance with some embodiments the device 1 may be powered by a Li-Ion battery. In the illustrated embodiment of FIG. 1A, 2S Li-Ion batteries 2 are used. It is to be appreciated however that any number of batteries may be used, and the precise number of batteries may be dictated by the required operational voltage. Accordingly, reference to two batteries in the following description of embodiments is for non-limiting, illustrative purposes only.

Returning to the embodiment of FIG. 1A, two, rechargeable Li-Ion batteries 2 are connected in series. The batteries can be charged by a 5 volts USB charger 4 or by wireless charging module 6. Wireless charging is included to increase the efficiency at the time of pre-deployment when the inspector is carrying the devices 1 in their car. The devices 1 can be plugged into the charging dock which chargers the device wirelessly. The status of the battery may be shown by a LED. The USB charger 4 and the wireless charging module 6 may interface with battery charger integrated circuit (IC) 8, which controls charging of the 2S Li-Ion batteries 2.

Additionally, device 1 may comprise a voltage divider 9. Voltage divider 9 may be configured to measure the voltage of batteries 2 and communicated this to microcontroller 12, to assist battery management.

### Voltage Regulation

Two DC-DC voltage regulators 10a, 10b may be comprised in the device 1. A first one 10a may always be on, and controls the voltage applied to a microcontroller 12 and sensors 14, 16, 18. In the illustrated embodiment of FIG. 1, the first DC-DC regulator 10a generates 3.3 volts applied to the microcontroller 12 and sensors 14, 16, 18. The second DC-DC voltage regulator 10b is used for powering up a communication module when it is operational and transmitting data to the server. The second DC-DC regulator 10b may be turned off by default when the communication module is not operational, and may be turned on by the microcontroller 12, when data needs to be transmitted to the server. Selectively activating the second DC-DC regulator 10b when the communication module is required, helps to reduce power consumption of the device 1.

### Low Voltage Cutoff

In accordance with some embodiments and as illustrated in FIG. 1B, device 1 may comprise a low-voltage cut-off device 24, such as a TLV 431. The low-voltage cut-off device 24 may be located between the Li-Ion batteries 2 and the first and second DC-DC voltage regulators 10a, 10b. In accordance with some embodiments the low-voltage cutoff may be set at 6V, to help safeguard battery life. The low-voltage cutoff device 24 may be configured as a precision shunt regulator. The low-voltage cutoff device 24 acts as a protective measure. When the battery voltage drops below a designated threshold value, such as 6V, the low-voltage cutoff device 24 initiates a cutoff mechanism to prevent further discharging of the battery 2, thus ensuring the battery voltage remains within the designated safe operating range. In this way, the connected circuit and/or electrical loads are safeguarded from potential damage due to low battery voltage, in addition to prolonging battery life.

### Battery Balancer

In accordance with some embodiments, device 1 may also comprise a battery balancer 26, as illustrated in FIG. 1B. The battery balancer 26 may be operatively connected to Li-Ion batteries 2. The battery balancer 26 is useful when the batteries 2 are charged using a USB charger 4 or wireless charger 6. A non-limiting example of a battery balancer 26 is BQ29209, which is a dedicated battery protection and balancing integrated circuit, designed to ensure uniform charging of a 2-cell battery pack. Whilst the purpose of the battery balancer 26 is to balance voltage level between individual battery cells, it also optimizes the performance and longevity of the battery 2. The battery balancer 26 may be configured to monitor the voltage of each battery cell and actively manage the charging of the cells to prevent imbalances that can occur naturally over time, or due to variations in cell characteristics. In this way, the battery balancer 26 is able to equalize the charge across both battery cells, promoting a harmonized voltage distribution. This not only improves overall battery efficiency but also safeguards against potential issues such as overcharging, which can negatively impact battery health and capacity.

### Control Unit

Microcontroller 12 may be configured to control the overall functionality of the device. In some embodiments microcontroller 12 may comprise a control unit. Whilst it is envisaged that the device 1 may comprise a single communication module 20 providing long-range communications, using for example, mobile telecommunications protocols, in some embodiments, such as the one illustrated in FIG. 1, two different communications devices may be provided. For example, the device 1 may be provided with a long-range communications device 20, and a short-range communications device 22. The long-range communications device 20 may be configured to use existing mobile telephony networks, such as 2G, 3G, 4G, 5G, NB-IoT/LTE-M, whereas the short-range communications device 22 may be configured to use Bluetooth® communications protocols. The short-range communications device 22 and the long-range communications device 20 may be operatively coupled to microcontroller 12.

It is to be appreciated that the functionality of microcontroller 12 may, in some embodiments, be replaced with a processor. Within the present context a processor may be understood as relating to a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), a neural processing unit (NPU), and any type of circuit capable of data processing.

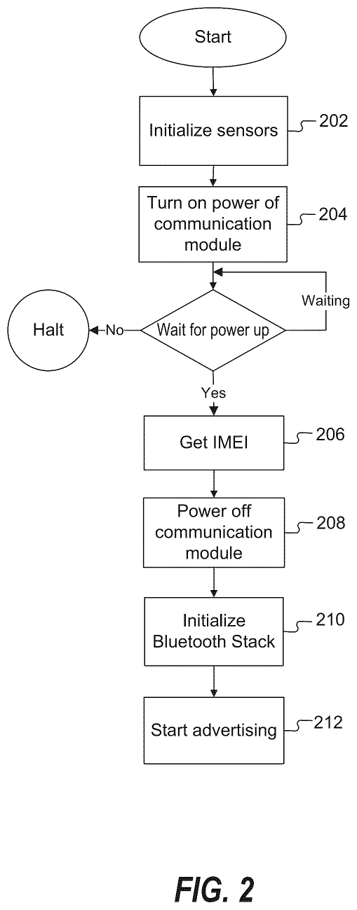

FIG. 2 is a process flow chart illustrating the initializing method carried out by device 1 on boot up. When the device 1 boots up it initializes the sensors 14, 16, 18, at step 202, and turns on the power of the long-range communication module 20, at step 204. Device 1 obtains its IMEI or unique identification, at step 206. This ID is used to identify each device 1 uniquely. After obtaining the device ID, the long-range communication module 20 goes into sleep mode, at step 208. While in sleep mode the short-range, Bluetooth, communication device 22 is still active and advertising itself to be found by, for example a smartphone. This may comprise the short-range communication device 22 initializing its Bluetooth® stack, at step 210. Following this, the short-range communication device 22 may commence advertising itself, at step 212.

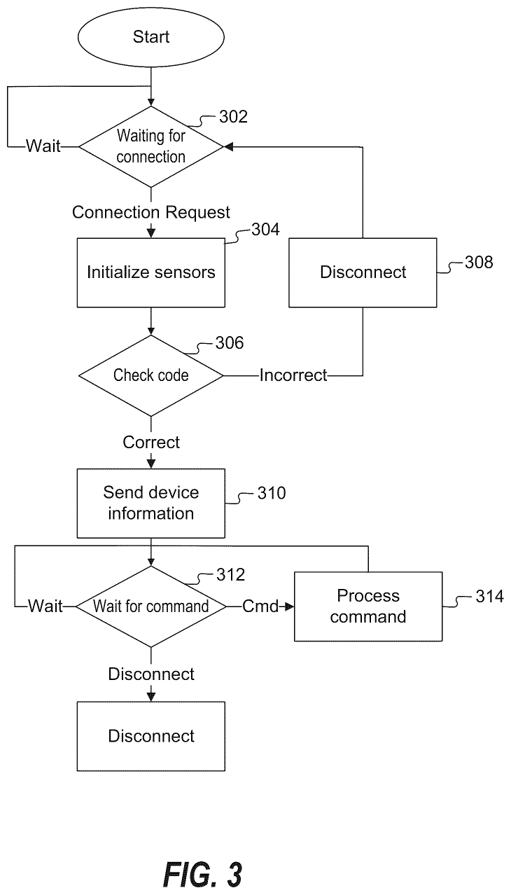

In accordance with some embodiments, the device 1 can only be activated by a smartphone application. Once the smart phone connects to the device 1 it shares a unique code. If the code is correct the device 1 allows other communications, otherwise no other communication is accepted by the device 1 and it disconnects itself from the smart phone (central device). This process is illustrated in the flowchart of FIG. 3. Short-range communication device 22 awaits a connection request, at step 302. When a connection request is received from a mobile telephone, at step 304, a connection is established between short-range communication device 22 and the requesting telephone. This comprises the mobile telephone providing a unique code to device 1 via short-range communications device 22. Device 1 checks the validity of the received code, at step 306. If the code is incorrect, then the connection with the mobile telephone is terminated, at step 308, and short-range communications device 22 reverts to awaiting receipt of a connection request from a mobile telephone, at step 302. If the received code is found to be valid, then device 1 proceeds to share device information with the requesting mobile telephone, at step 310. At this stage, the mobile telephone may send further commands to the device 1, at step 312. Any subsequently received commands are processed at step 314. Such commands may, for example, relate to device configuration commands.

Non-limiting examples of the type of device information that may be shared with the mobile telephone include:
Device ID;
Device Bluetooth MAC;
Firmware version and Hardware version;
Battery level;
Activated sensors; and
Device Status—active or not active

Once a connection has been successfully established between the device 1 and the mobile telephone, a user may select one or more configuration commands for device 1, via a mobile app running on the connected mobile telephone. Such configuration commands may comprise commands instructing device 1 to activate one or more required sensors 14, 16, 18 comprised in device 1. The mobile app may comprise a graphical user interface through which user commands may be selected. Once configuration commands have been selected for a given device, a record of the selected commands may also be shared with the server. For example, once a configuration command has been selected for a specific device, the mobile app fetches the location of the corresponding device and subsequently posts the details to the sever, along with the IMEI of the device, the shop name and location.

Once a sensor 14, 16, 18 of device 1 has been activated it records sensor data. For example, whenever there is a movement, or any other sensor data recorded from any one of the plurality of sensors 14, 16, 18 comprised in device 1, device 1 will detect it from the relevant sensor and turn on the power of the long-term communication module 20, to send the recorded data to the server via the cloud. Once the recorded sensor data has been transmitted, long-term communication module 20 may be powered off. In this way, any recorded sensor data is transmitted to the server, which helps to prevent device tampering.

### Sensors

While a single sensor may suffice to detect tampering, for improved security, the device may comprise a plurality of different sensors configured to detect different types of tampering. With reference to the embodiment illustrated in FIG. 1, four types of sensors are provided in the device: a GPS sensor 18, a magnetic sensor 16, which may comprise a reed switch, a limit switch 15 to detect if the seal is or has been tampered with, and an Inertial Measurement Unit (IMU) sensor 14. The IMU sensor 14 may comprise an accelerometer, a gyroscope, and a magnetometer. The use of additional sensors is also envisaged.

The device 1 may be configured with a low power algorithm to detect opening and closing of the door by using sensor data. Different sensor data may be used for this purpose. The device 1 may also be configured to use sensor data to detect tampering with the device 1, such as if the device 1 has been removed from the door to which it is affixed.

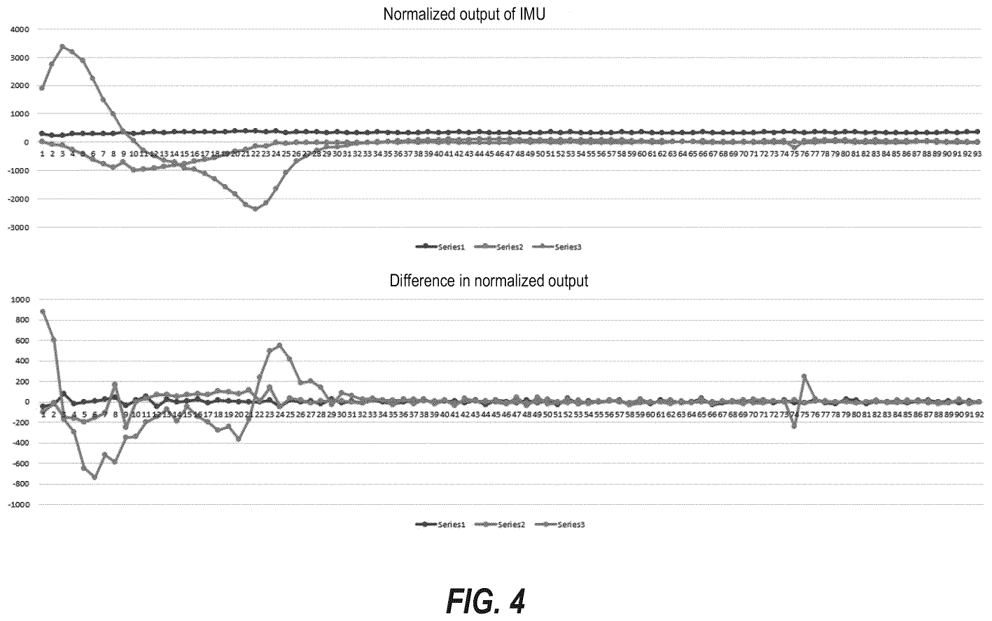

One non-limiting example of the type of sensor data which may be used is, for example, accelerometer data captured by the IMU sensor 14. In accordance with some embodiments, the IMU sensor 14 is configured to detect motion of the device 1 from accelerometer data and/or gyroscope data. When the device 1 is fit to a door, motion data may relate to motion of the door, such as when the door is opened. Similarly, if the device 1 is physically removed from the object it is affixed to, such as the door, this motion is also captured. The algorithm is implemented by normalizing the IMU sensor data, such as the accelerometer data and/or gyroscope data, storing it in internal memory at the time of activation. After that the sensor is kept in sleep mode with interrupt enabled. Whenever movement is detected, the sensor wakes up. This helps to reduce power consumption. Once the sensor is active, accelerometer data is fetched for the next two hundred normalized readings or until no activity is observed, whichever comes first. This data may then be analyzed to check the maximum positive value and maximum negative value. Also, the system may take the difference between each reading and check the maximum positive value and maximum negative value of the difference. If the maximum and minimum readings are equal to or below a threshold, and the difference is equal to or below the threshold, the output may be marked as the door is open or closed. FIG. 4 is a graph illustrating normalized IMU sensor output data, according to one embodiment of the present disclosure. The top graph illustrates the normalized IMU sensor data. The lower graph illustrates the difference in normalized sensor data output. Each graph comprises three different curves, where each curve represents accelerometer data along a different one of the x,y and x axes.

Sensor data output from the limit switch 15 may be used to detect tampering of the device 1. For example, in use the limit switch 15 is maintained in a deactivated state. When the device 1 is installed on a door, limit switch 15 is pressed, which deactivates the sensor. While the device 1 is fixated to the door, limit switch 15 is maintained in the deactivated form. If the device 1 is removed from the door, limit switch 15 is depressed and activated. When activated, limit switch 15 sends a control signal to the microcontroller 12 indicative of a change in the state of the limit switch 15, caused by tampering, such as removal of the device 1 from the door. An alert is subsequently generated by microcontroller 12 and sent to the backend server via long-range communication device 20, in response to the limit switch 15 outputting the control signal.

In accordance with some embodiments, the magnetic sensor 16 may comprise a reed switch. The reed switch may be used in combination with a magnet. The reed switch may be located inside the device 1, and the magnet may be placed on the object being secured, such as the frame of a door. When the door is closed, the reed switch senses the magnetic field of the magnet and the reed switch is closed completing an electrical circuit. The reed switch may be configured such that when the electrical circuit is closed the output is grounded. When the door is opened the reed switch is pulled away from the magnet, it experiences a weaker magnetic field, resulting in the switch opening and disrupting the internal electrical circuit. As a result, the profile of an electrical signal output to the microcontroller 12 changes. For example, the act of disrupting the internal electrical circuit of the reed switch may cause a temporary voltage spike. In this way, the microcontroller 12 is able to detect when the device 1 has been removed from the door, and more specifically when the magnetic contact between the reed switch and the magnet affixed to the door has been broken.

In accordance with some embodiments, the device 1 may also comprise a magnetometer. In accordance with some embodiments, the magnetometer may be comprised in the IMU sensor 14. Sensor data from the magnetometer may be used to determine if the device 1 has been displaced. For example, when affixed to secure a door, sensor data from the magnetometer may be used to determine if the door has been opened, or if the device 1 has been removed from the door. This may be achieved by monitoring changes in the measured magnetic field of the earth along an axis relative to a designated reference value. The axis may be selected to have at least one component in a direction of opening of the door. The reference value may be calibrated to correspond with the magnetic field reading when the door is in the closed position. This reference value may be stored at the time of deployment when the door of the business is closed. If the door is opened, the magnetometer will measure a change in magnetic field with respect to the stored reference value, indicating that the relative position of the device has changed, and therefore that either the door has been opened, or the device has been removed from the door. Sensor data associated with other available sensors, such as GPS, may be used to distinguish between the two scenarios. An observed change in magnetic field is indicative that the device has been tampered with. When used in combination with an accelerometer, for example the IMU sensor 14, and once accelerometer data is measured, such as a movement interrupt, the microcontroller 12 may be configured to obtain further magnetometer sensor data to confirm that the door has been opened. If the door is open the magnetic field reading with respect to earth's magnetic field will also change. Thus, sensor data from different sensors may be used to complement each other, to achieve a better situational awareness regarding the device 1.

The device 1 may also comprise a GPS sensor 18 configured to monitor the geographical location of the device 1. If the device 1 is physically removed from the location of the object it is affixed to, such as a door, then its geographical location will change too, thus providing yet a further means for detecting tampering of the device 1.

In accordance with some embodiments, and as illustrated in FIG. 1B device 100 may also comprise one or more environmental sensors configured to measure one or more environmental parameters. Non-limiting example of the environmental parameters, may comprise one or more of: Air Quality Index (AQI), Total Volatile Organic Compound (TVOC) readings, Temperature, Humidity, and Carbon Dioxide. The embodiment of FIG. 1B comprises two environmental sensors. A first one of the environmental sensors may comprise an ENS160 environmental sensor 30 configured to measure AQI and/or TVOC. A second one of the environmental sensors may comprise an SCD40 sensor 32 configured to provide Temperature, Humidity and Carbon Dioxide readings. In accordance with some embodiments, the environmental sensors may be remotely operated. For example, upon receiving a control signal from a remote server, the environmental sensors may be activated. The control signals may additionally specify the sensor sampling frequency at which sensor readings are taken. The control signals may also dictate different sampling frequencies for different environmental parameters. Similarly, control instructions for operation of the environmental sensors 30, 32 may also be stored local to device 100, including sensor sampling measurement frequencies.

### Communication Medium

In accordance with some embodiments, the long-range communication device 20 may comprise a modem enabling 2G, 3G or NB-IoT communications. Whenever there is a violation detected by the sensors 14, 15, 16, 18, it may be stored in flash memory 28, and a que of violation is created. In case multiple sensors 14, 15, 16, 18, detect a violation (e.g. tampering), this data is queued, and the long range communication device 20 is enabled. The device 1 calls a POST API to the server to send the data to the server. In case it fails it does not clear the queue. If the device 1 is unable to post the data, it may choose to advertise the violation status using the short-range communication device 22. In other words, device 1 may change its Bluetooth® advertising packet to include the violation status. In this way, any relevant authority figures, such as inspectors, that are patrolling in the vicinity of the device 1, that are equipped with short-range communication gateways, such as Bluetooth® gateways, may detect the broadcast signal. The broadcast data may subsequently be relayed to the server via the relevant authority figure (e.g. the inspector). This helps to ensure that the data is posted to the server. Thus, in some embodiments the short-range communications device 22 may be configured to act as a backup when the long-range communications device 20 is unavailable, or otherwise fails.

### Device Operation Mode

The device 1 may also be configured as a central device or a gateway device for a plurality of other sensors. For example, device 1 may change its mode of operation from being a standalone peripheral device, to being a central device or a gateway for a plurality of other devices in its vicinity. This enables the plurality of other devices to relay sensor information they may have recorded to the cloud using the communications channels available to the central or gateway device. In other words, a plurality of devices 1 may be configured in a star network, in which the central node acts as a gateway device to the backend server. The mode of operation of each device 1 may be configured via a mobile application running on a user's mobile device. While the device 1 is in scanning mode it also advertises its advertisement packets in order to ensure that the device is still connectable to a smart phone. This is achieved via receiving advertising packets from other beacon devices.

### Expansion Header for Other Environmental Sensors

Expansion header is equipment with inter-integrated circuit (i2c) and power. Different environmental sensors based on the required application may be installed on this header. This enables relevant environmental information to be periodically collected. The power of this expansion header can be turned off to save battery.

### Server

The backend server is configured to receive data transmissions from the devices 1. The data transmissions may be configured in the form of a data packet, which data packet contains the information of the store, location of the device 1, and the action type triggering the data transmission. The location from which the received data transmissions are transmitted may be graphically represented on a map comprised in a web application.

### Network Architecture

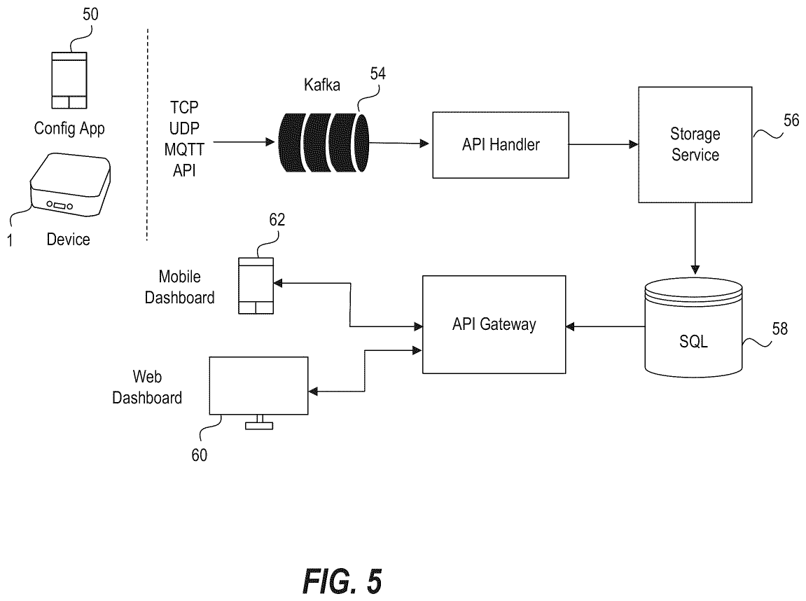

FIG. 5 illustrates a network architecture used to communicate sensor data from device 1 to a backend server, according to an embodiment of the present disclosure. As mentioned previously, a device 1 may be configured by a mobile device 50. Sensor data, which may be generated in response to tampering of the device 1, may be transmitted to a Kafka 54. The Kafka 54 may forward the received sensor data to a storage service device, such as a cloud storage device 56 comprising a database 58, via an API interface running on the Kafka 54. Data stored in database 58 may be accessed and visualized by a remote computing terminal running 60 a Web dashboard, or by a mobile device 62, via an API gateway. Remote computing terminal 60 and/or mobile device 62 enable a remote administrator, such as a municipality official to monitor the status of device 1, and in particular to detect if device 1 has been tampered with, from sensor data stored in database 58. As mentioned previously, information may be graphically presented to the remote administrator. For example, locations and sensor alerts may be projected on a virtual map displayed on remote computing terminal 60 and/or mobile device 62.

### Use-Cases

Non-limiting examples of the scenarios in which the device may be used for tamper detection include:
Detecting if a door to a shop subject to restricted access has been accessed;
Smart Sealing of a portal or premises;
Used as Bluetooth LE gateway to scan seal beacons;
As a security alert system for a shop owner to detect unauthorized access to a premises; and
Using the door sensors by relevant authorities to restrict access to a required premises, to ensure compliance with a municipality restriction order.

While illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A device for detecting if a movable barrier obstructing a portal has been opened, the device comprising:
at least one sensor configured to detect when the barrier is manipulated from a closed position in which the portal is obstructed, to an open position enabling access to the portal; and
a processor configured to generate a first alert message when sensor data indicative of the barrier being manipulated from the closed position to the open position, is received; and
a communication module for wirelessly transmitting the first alert message to a remote entity.

2. The device of claim 1, wherein the communication module comprises a first communication module and a second communication module, the first communication module enabling long range wireless communications, and the second communication module enabling short-range wireless communications.

3. The device of claim 2, wherein the first communication module enables communication over a mobile telephone network, and the second communication module enables communication via Bluetooth®.

4. The device of claim 3, wherein the mobile telephone network comprises any one or more of: 2G, 3G, 4G, 5G, LTE-M, or NB-IoT.

5. The device of claim 1, wherein the at least one sensor comprises a motion sensor configured to detect motion of the barrier when it is manipulated from the closed position to the open position; and
the processor is configured to generate the first alert message when motion sensor data indicative of the barrier being manipulated from the closed position to the open position is received.

6. The device of claim 5, wherein the motion sensor comprises an accelerometer configured, when the device is at least partly affixed to the barrier, to measure an acceleration of the barrier when the barrier is manipulated from the closed position to the open position.

7. The device of claim 6, wherein the accelerometer comprises a gyroscope.

8. The device of claim 1, wherein the at least one sensor comprises a magnetic sensor configured, when the device is at least partly affixed to the barrier, to measure a change in earth's magnetic field strength along an axis having a component in a direction of displacement of the barrier when it is manipulated from the closed position to the open position; and
the processor is configured to generate the first alert message in response to receipt of the measured change in earth's magnetic field strength.

9. The device of claim 1, wherein the device is at least partly affixed to the barrier, a magnet is affixed to the portal, and the at least one sensor comprises:
a reed switch configured to be in a closed position when the barrier is in the closed position and the reed switch experiences the magnetic field strength of the magnet;
the reed switch is configured to be in an open position when the barrier is in the open position where the magnetic field strength of the magnet is insufficient to close electrical contacts of the reed switch; and
wherein the processor is configured to generate the first alert message when the reed switch is in the open position.

10. The device of claim 1, wherein the at least one sensor comprises a position sensor configured, when the device is at least partly affixed to the barrier, to measure a position of the device; and
the processor is configured to generate the first alert message when position sensor data indicative of the position of the device having changed, is received.

11. The device of claim 10, wherein the position sensor comprises a Global Positioning System “GPS” sensor.

12. The device of claim 1, further comprising a tamper sensor configured to detect if the device has been removed from a surface to which it was affixed; and
the processor is configured to generate a second alert message when tamper sensor data indicative of the device having been removed from the surface to which it was affixed is received.

13. The device of claim 12 wherein the tamper sensor comprises a limit switch.

14. The device of claim 1, wherein the barrier is a door and the portal is a doorway.
